(19) United States
(12) Patent Application Publication
(10) Pub. No.: US 2025/0319510 A1
(43) Pub. Date: Oct. 16, 2025

(54) TUBE EXPANSION METHOD OF TUBULAR MATERIAL AND TUBULAR MATERIAL PARTS MANUFACTURED USING THE SAME

(71) Applicants: HYUNDAI MOTOR COMPANY, Seoul (KR); KIA CORPORATION, Seoul (KR)

(72) Inventors: Deuk-Yong Kim, Hwaseong-si (KR); Seong-Su Shin, Hwaseong-si (KR); Joon-A Yeo, Suwon-si (KR); Dae-Kern Kang, Seongnam-si (KR); Ho-Jin Lee, Siheung-si (KR)

(73) Assignees: HYUNDAI MOTOR COMPANY, Seoul (KR); KIA CORPORATION, Seoul (KR)

(21) Appl. No.: 18/947,857

(22) Filed: Nov. 14, 2024

(30) Foreign Application Priority Data
Apr. 11, 2024 (KR) 10-2024-0048586

(51) Int. Cl. B21D 26/033

(52) U.S. Cl. CPC B21D 26/033

(57) ABSTRACT

A tube expansion method of a tubular material includes extruding a tubular material in which a hollow is formed, inserting the tubular material into a cavity of a mold corresponding to a shape of a part to be manufactured, and performing hydroforming by injecting a pressure medium into the hollow of the tubular material at a predetermined pressure or higher, wherein a tubular material extruded through the extruding step has portions with different thicknesses along the circumferential direction. Tube expansion of the tubular material with different cross-sectional sizes in one piece is possible.

### CROSS-REFERENCE(S) TO RELATED APPLICATIONS

This application claims priority to Korean Patent Application No. 10-2024-0048586, filed on Apr. 11, 2024, which is incorporated herein by reference in its entirety.

### BACKGROUND

### Technical Field

Embodiments of the present disclosure relate to a tube expansion method of a tubular material, and more particularly, to a molding method using hydroforming, and tubular material parts manufactured using the same.

### Related Art

Hydroforming technology is a production technology suitable for component integration and weight reduction, but has limitations in forming complicated shapes due to molding limitation of a material and difficulty in controlling a molding process.

Formable shapes include eccentric bulging, pre-bended pipe bulging, asymmetric bulging, and flange bulging.

In other words, there are clear molding limitations depending on materials, and bursting may occur during molding of parts, or a defect such as wrinkling or buckling may occur as a result of inappropriate process control.

Due to the above-described problems occurring in hydraulic molding of hollow materials, it is impossible to mold an integrated-type tube product with a cross-sectional size difference for each portion, and thus a product is manufactured in a separate combination structure of an extrusion and a press product.

For example, when a cross-sectional size is different for each portion, as shown in FIGS. 1 and 2, fracture may occur during hydroforming of an elliptical tubular material 1 with a single thickness, and also as shown in FIGS. 3 and 4, fracture may occur during hydroforming of a prismatic tubular material 2 with a single thickness.

The contents described in the above Related Art are to aid understanding of the background of the present disclosure and may include what is not previously known to those having ordinary skill in the art to which the present disclosure pertains. In other words, the statements in this Background section merely provide background information related to the present disclosure and may not constitute prior art.

### SUMMARY

An embodiment of the present disclosure is directed to providing a tube expansion method of a tubular material in one piece, which has a different cross-sectional size for each portion, and tubular material parts manufactured using the same.

Other objects and advantages of the present disclosure can be understood by the following description and become apparent with reference to the embodiments of the present disclosure. Also, it is understood to those having ordinary skill in the art to which the present disclosure pertains that the objects and advantages of the present disclosure can be realized by the means as claimed and combinations thereof.

In accordance with an embodiment of the present disclosure, a tube expansion method of a tubular material includes: extruding a tubular material in which a hollow is formed; inserting the tubular material into a cavity of a mold corresponding to a shape of a part to be manufactured; and performing hydroforming by injecting a pressure medium into the hollow of the tubular material at a predetermined pressure or higher. The tubular material extruded through the extruding step has portions with different thicknesses along the circumferential direction.

In addition, the portions of the tubular material having different thicknesses in the circumferential direction may include a first portion with a first thickness and a second portion with a second thickness. The first thickness is greater than the second thickness. Strain of the first portion formed by the performing of the hydroforming may be greater than strain of the second portion formed by the performing of the hydroforming.

In addition, the portions of the tubular material having different thicknesses in the circumferential direction may include a first portion with a first thickness and a second portion with a second thickness. The first thickness is greater than the second thickness. In the performing of the hydroforming, the first portion may contact an inner wall surface of the mold later than the second portion.

In addition, the portions of the tubular material having different thicknesses in the circumferential direction may include a first portion with a first thickness and a second portion with a second thickness. The first thickness is greater than the second thickness. A gap between the first portion and an inner wall surface of the mold facing the first portion may be greater than a gap between the second portion and an inner wall surface of the mold facing the second portion.

In addition, the part formed by the hydroforming may have portions with different lengths of an outer circumference of a cross-sectional plane.

In addition, the tubular material extruded through the extruding step has portions with three or more different thicknesses along the circumferential direction. For example, the tubular material has three or more portions with different thicknesses in the circumferential direction.

In addition, portions of the tubular material having different thicknesses in the circumferential direction may be formed at a plurality of positions in a longitudinal direction of the tubular material.

Furthermore, in portions of the tubular material with different thicknesses in the circumferential direction, a thickness change between adjacent portions with different thicknesses in the circumferential direction may be linear, and a thickness change between portions with different thicknesses not adjacent to each other may be non-linear.

Next, a tubular material part may be manufactured in one piece (i.e., may be manufactured as a single piece) by the tube expansion method according to the present disclosure.

The tubular material has parts with different outer circumference lengths.

### BRIEF DESCRIPTION OF THE DRAWINGS

FIG. 1 is a diagram illustrating a tubular material according to one example.

FIG. 2 is a diagram illustrating a state during hydroforming of the tubular material of FIG. 1.

FIG. 3 is a diagram illustrating a tubular material according to another example.

FIG. 4 is a diagram illustrating a state during hydroforming of the tubular material of FIG. 3.

FIG. 5 is a diagram illustrating a shape of a part manufacturable by a tube expansion method according to an embodiment of the present disclosure.

FIG. 6 is a diagram illustrating a state before molding by the tube expansion method of a tubular material according to an embodiment of the present disclosure.

FIG. 7 is a diagram illustrating a state after molding by the tube expansion method of a tubular material according to an embodiment of the present disclosure.

FIG. 8 is a diagram illustrating one example of thicknesses of the tubular material before hydroforming according to an embodiment of the present disclosure.

FIG. 9 is a diagram illustrating a state during molding by the tube expansion method of a tubular material according to an embodiment of the present disclosure.

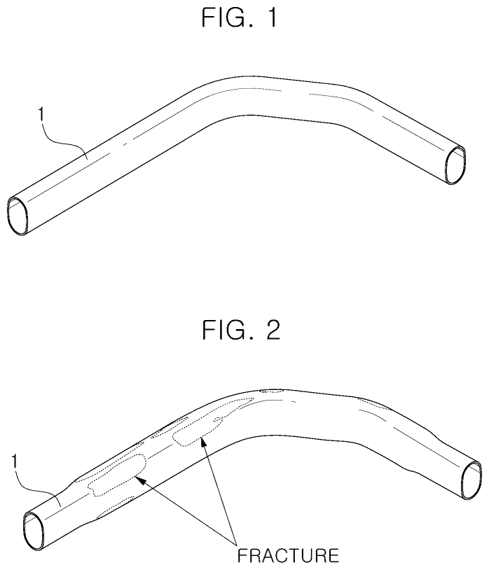

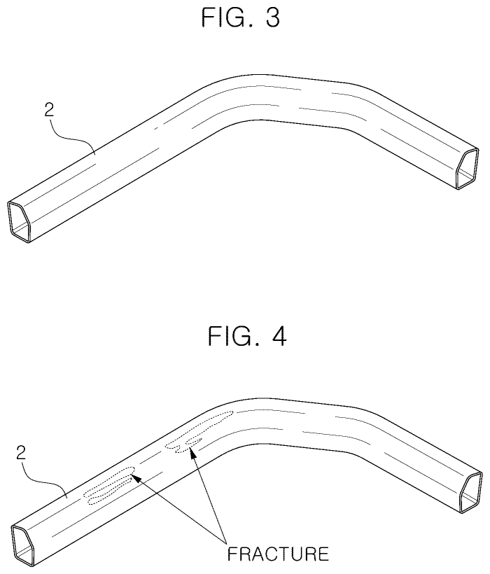

The drawings described herein are for illustration purposes only and are not intended to limit the scope of the present disclosure in any way.

### DETAILED DESCRIPTION

In order to fully understand the present disclosure and operational advantages of the present disclosure and objects attained by practicing the present disclosure, reference should be made to the accompanying drawings that illustrate embodiments of the present disclosure and to the description in the accompanying drawings.

In describing embodiments of the present disclosure, known technologies or repeated descriptions may be reduced or omitted to avoid unnecessarily obscuring the gist of the present disclosure.

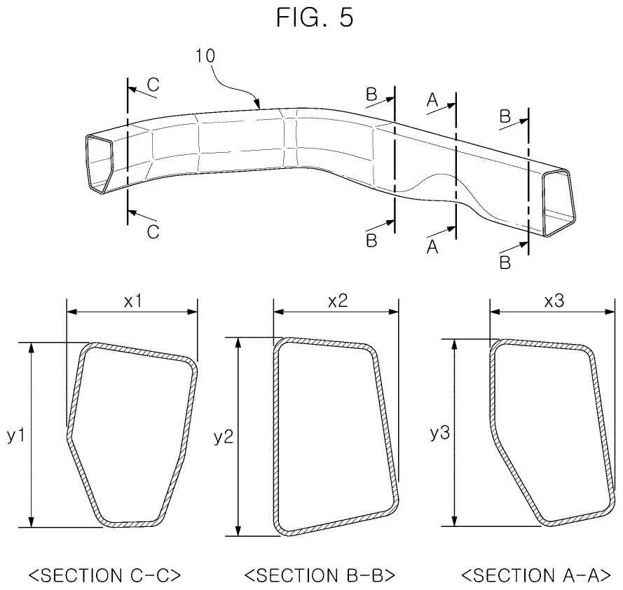

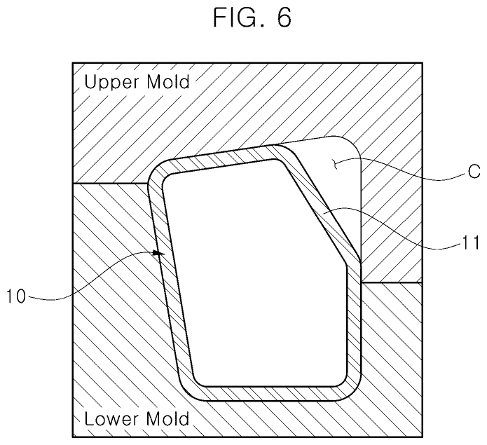

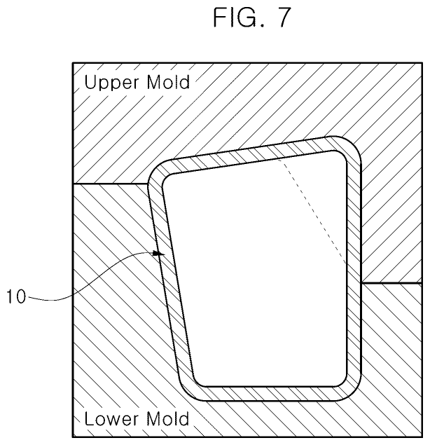

An embodiment of the present disclosure provides a method of manufacturing a tubular material with a final product shape as shown in FIG. 7. The method includes preparing a tubular material 10 as shown in FIG. 5 by extruding the tubular material 10 using an extruder in order to mold and manufacture a hollow part. The method also includes inserting the tubular material into a cavity C of a mold corresponding to the final product shape as shown in FIG. 6, and performing hydroforming by applying a high pressure to an inside of the tubular material to expand the tubular material. An embodiment of the present disclosure also provides tubular material parts manufactured using the same.

According to an embodiment of the present disclosure, in the tube expansion, the tube expansion of the tubular material 10, which includes portions with different cross-sectional plane sizes, is possible as shown in FIG. 5 so that it is possible to reduce a weight without quality degradation due to hydroforming and to overcome limitations of shapes of a material to be manufactured.

In other words, when hydroforming is performed on a hollow tubular material whose cross-sectional plane size is different for each portion or whose a cross section is polygonal, it is possible to form by hydroforming what is impossible due to fracture according to the related art.

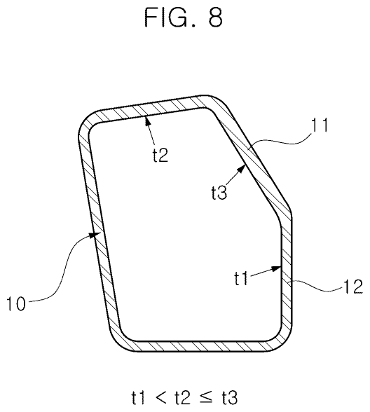

To this end, according to the tube expansion method of a tubular material according to an embodiment of the present disclosure, the tubular material 10 is extruded and prepared before hydroforming. Referring to FIG. 8, a thickness t3 of a portion 11 in a different-shaped tubular material, which requires a lot of strain in a circumferential direction, is extruded and manufactured to be greater than a thickness t1 of a portion 12, which requires relatively less molding (e.g., strain or less deformation), to overcome occurrence of bursting during hydroforming.

In other words, an embodiment of the present disclosure provides a technology in which a portion where a timing for contact between the tubular material and a mold is relatively small (e.g., sooner/earlier) because relatively less molding (or deformation) is required has a relatively thin (e.g., thinner) thickness, and a section (or a portion) where a timing for contact between the tubular material and the mold is relatively late (e.g., later) because much (e.g., greater) forming (or deformation) is required has a relatively thick (e.g., thicker, greater) thickness, thereby expanding a uniform elongation section.

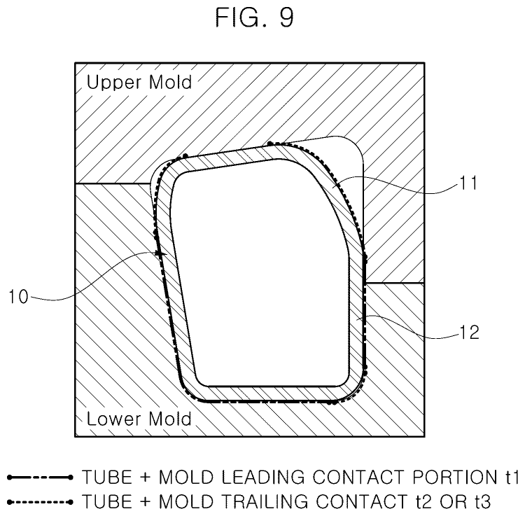

When the tubular material 10 for hydroforming is prepared, a thickness is varied in the circumferential direction as shown in FIG. 8, and referring to FIGS. 6, 7, and 9, except for portions 12 (requiring less molding) that have small strain & when finally molded even by being in contact with molds (an upper mold and a lower mold) from the beginning or by being in contact with the molds early, when a thickness of the portion 11 (requiring a lot of molding) where a contact with the mold is expected to be delayed and thus the strain & is expected to be large is thick, an acting area A_{thick} defined as the product of the thickness and a length of this portion is greater than an acting area Aₜₕᵢₙ of a portion with a thin thickness, and thus an acting force F generated due to an action of a molding pressure is the same in the thick portion and the thin portion so that stress of the thin portion, which is locally applied, becomes greater than a stress applied to the thick portion. In this case, when the molding pressure is appropriately applied, since the stress applied to the thin portion exceeds yield stress and the stress applied to the thick portion is less than the yield stress, deformation begins in the thin portion first and the stress δ_{thick} in the thick portion is less than the stress δₜₕᵢₙ in the thin portion and the yield stress so that deformation of the thick portion does not occur yet. In addition, as the deformation of the thin portion progresses, a contact with the mold occurs and the deformation is suppressed due to friction and limitations in the shape of the mold.

Continuously, as the applied force increases due to an increase in the molding pressure, in a situation in which the deformation of the thin portion is suppressed, the stress in the thick portion exceeds the yield stress and thus deformation begins in the thick portion. Since the thickness of the material is designed to increase continuously from the thinnest portion to the thickest portion, the deformation of the material begins from the thinnest portion to be in contact with the mold, and then the deformation is continuously transferred to the thicker portion and occurs late in the order in which a contact with the mold occurs later. Eventually, there is an effect of uniformly deforming the entire tubular material so that it is possible to mold the tubular material into a desired shape of the part.

Therefore, under the same applied force, since the strain & of the thick portion is less than that of other thin portions due to an external mold shape and the deformation of the thick portion progresses slower over time, and thus a plastic deformation margin of the thick portion is greater than that of the thin portion, molding may be achieved at a level similar to an intrinsic elongation of the material without defect occurrence so that tube expansion (bulging) into a complicated shapes is possible.

The extruded tubular material is charged into a mold having a shape of a final part, and both ends of the tubular material are sealed using a punch, a pressure medium is injected into a tube using a medium injector, and a high pressure is applied so that the extruded tubular material is molded into a final product through a tube expansion (bulging) process. Defects that occur during the molding process include bursting, bending, and wrinkling. Defects can be prevented by optimizing the process progress. According to an embodiment of the present disclosure, material bursting can be avoided especially.

In addition, the thicknesses of the thin and thick portions of the tubular material can be designed and applied to change linearly or nonlinearly.

In other words, a thickness change between the thick and thin portions adjacent to each other of the tubular material may be linear, and a thickness change between portions with different thicknesses and not adjacent to each other may be non-linear.

The recent vehicle development trend is moving toward eco-friendly electric vehicles, and there is an urgent need for weight reduction of a vehicle body along with electrification of batteries and driving devices.

Hydroforming is getting attention as a production technology for manufacturing parts suitable for weight reduction. However, in the existing hydroforming, it is difficult to overcome a molding limitation of a material, and thus there are limitations in products that can be molded. According to a method proposed in the present disclosure, a thickness of a tubular material is set variably in a circumferential direction to obtain uniform strain in all portions of the material, and when molding is performed using an internal pressure, bursting occurrence of the material is suppressed (a uniform elongation section is increased, and a time point of occurrence of concentrated stress is delayed).

In addition, it is possible to mold parts in that form which is impossible to be molded due to defects according to the related art so that parts of a vehicle, which require weight reduction, can be easily manufactured.

While the present disclosure has been described with reference to the accompanying drawings, it should be apparent to those having ordinary skill in the art that various changes and modifications can be made without departing from the spirit and scope of the present disclosure without being limited to the embodiments disclosed herein. Accordingly, it should be noted that such alternations or modifications fall within the claims of the present disclosure, and the scope of the present disclosure should be construed on the basis of the appended claims.

What is claimed is:

1. A tube expansion method of a tubular material, comprising:
extruding a tubular material in which a hollow is formed;
inserting the tubular material into a cavity of a mold corresponding to a shape of a part to be manufactured; and
performing hydroforming by injecting a pressure medium into the hollow of the tubular material at a predetermined pressure or higher,
wherein the tubular material extruded through the extruding step has portions with different thicknesses along a circumferential direction.

2. The tube expansion method of claim 1, wherein:
the portions of the tubular material having different thicknesses in the circumferential direction include a first portion with a first thickness and a second portion with a second thickness, wherein the first thickness is greater than the second thickness; and
strain of the first portion is greater than strain of the second portion.

3. The tube expansion method of claim 1, wherein:
the portions of the tubular material having different thicknesses in the circumferential direction include a first portion with a first thickness and a second portion with a second thickness, wherein the first thickness is greater than the second thickness; and
in the performing of the hydroforming, the first portion contacts an inner wall surface of the mold later than the second portion.

4. The tube expansion method of claim 1, wherein:
the portions of the tubular material having different thicknesses in the circumferential direction include a first portion with a first thickness and a second portion with a second thickness, wherein the first thickness is greater than the second thickness; and
a gap between the first portion and an inner wall surface of the mold facing the first portion is greater than a gap between the second portion and an inner wall surface of the mold facing the second portion.

5. The tube expansion method of claim 1, wherein the part formed by the hydroforming has portions with different lengths of an outer circumference of a cross-sectional plane.

6. The tube expansion method of claim 1, wherein the tubular material has three or more portions with different thicknesses in the circumferential direction.

7. The tube expansion method of claim 1, wherein portions of the tubular material having different thicknesses in the circumferential direction are formed at a plurality of positions in a longitudinal direction of the tubular material.

8. The tube expansion method of claim 1, wherein, in portions of the tubular material with different thicknesses in the circumferential direction, a thickness change between adjacent portions with different thicknesses in the circumferential direction is linear, and a thickness change between portions with different thicknesses not adjacent to each other is non-linear.

9. A tubular material part manufactured in one piece by the tube expansion method of claim 1.

10. The tubular material part of claim 9, wherein the tubular material part has portions with different outer circumference lengths.
